(19) United States
(12) Patent Application Publication
(10) Pub. No.: US 2005/0011325 A1
(43) Pub. Date: Jan. 20, 2005

(54) Light beam rotary saw cut alignment device

(76) Inventor: Raymond J. Caluori, Quincy, MA (US)

Correspondence Address: MIRICK O'CONNELL;ATTORNEYS AT LAW, MIRICK, O'CONNELL, DEMALLIE & LOUGEE, LLP, 1700 WEST PARK DRIVE, WESTBOROUGH, MA, 01581-3941, US

(21) Appl. No.: 10/878,988

(22) Filed: Jun. 28, 2004

Related U.S. Application Data
(63) Continuation-in-part of application No. 10/207,502, filed on Jul. 29, 2002.

(51) Int. Cl. B26D 7/00

(52) U.S. Cl. 83/520; 83/469

(57) ABSTRACT

A cut alignment device for a rotary saw having a motor which spins a cutting unit which includes a rotary shaft driven by the motor, a circular blade having a central aperture through which the shaft fits, and a structural housing. The cut alignment device includes the structural housing defining two or more internal compartments, a battery power source carried within the structural housing; and a beam light source, operatively connected to this power source, and also within the structural housing. The light source projects a light beam from the cutting unit directed to intersect the plane of the rotary cutting tool or saw blade, to assist the operator in cutting accurately.

### CROSS REFERENCE TO RELATED APPLICATION

This application is a continuation in part of application Ser. No. 10/207,502 filed on Jul. 29, 2002. Priority is claimed.

### FIELD OF THE INVENTION

This invention relates to a saw-mounted cut alignment device for a rotary saw which projects a line of light along the cut line.

### BACKGROUND OF THE INVENTION

Rotary saws such as circular saws, chop saws, radial arm saws, miter saws and table saws require that the operator properly align the material being cut with the saw blade. This takes time and care, but is critical for a proper cut.

There exist laser-based cut alignment devices which are externally mounted in the vicinity of the saw, and project a light beam along the cut line. These devices must be manually aligned before cutting begins, thus requiring experience and additional time. Also, the operator must monitor this additional piece of equipment in order to use the alignment device properly. Accordingly, devices of this nature are not practical for most saw owners and operators.

### SUMMARY OF THE INVENTION

It is therefore an object of this invention to provide a cut alignment device for a rotary saw.

It is a further object of this invention to provide such a cut alignment device which is mounted to the saw.

It is a further object of this invention to provide such a cut alignment device which is automatically self-aligning with the blade cut line.

It is a further object of this invention to provide such a cut alignment device that requires no operator set-up.

It is a further object of this invention to provide such a cut alignment device that illuminates a line on the material to be cut along the blade cut line.

It is a further object of this invention to provide such a cut alignment device that turns on only when the saw is activated.

It is a further object of this invention to provide such a cut alignment device that decreases the amount of time required for a saw operator to align the material with the cutting edge of the saw blade.

It is a further object of this invention to provide such a cut alignment device that increases the safety of operating the saw.

This invention results from the realization that rotary saws can be made more accurate and easier to use with a light-source mounted on the rotating portion of the saw which projects a beam of light along the saw blade cutting line.

This invention features a cut alignment device for a rotary saw having a motor which spins a cutting unit which includes a rotary shaft driven by the motor, a circular blade having a central aperture through which the shaft fits, and a blade mounting device for holding the blade on the shaft, the cut alignment device comprising: a battery power source carried by the cutting unit; and a beam light source, operatively connected to the power source, and carried by the cutting unit; wherein the light source projects a light beam from the cutting unit directed along the plane of the blade, to assist the operator in cutting accurately.

The cut alignment device may further include a switch between the power source and the light source for selectively applying power to the light source. The switch may be centrifugally engaged to automatically power the light source when the shaft is spinning. The light source may be mounted within the blade mounting device, and the blade mounting device may define an aperture from which the light beam emanates. The device may further include a focusing lens aligned with the aperture for focusing the light from the light source.

The blade-mounting device may include a structural housing held on the shaft against the blade, and wherein the light source is mounted within the structural housing. The battery power switch may also be mounted within the structural housing.

Also featured is a cut alignment device for a rotary saw having a motor which spins a cutting unit which includes a rotary shaft driven by the motor, a circular blade having a central aperture through which the shaft fits, and a blade mounting device for holding the blade on the shaft, the cut alignment device comprising: a battery power source mounted within the blade lock washer; a light source operatively connected to the power source and mounted within the blade lock washer, wherein the blade lock washer defines an aperture from which the light emanates; and a centrifically-engaged switch between the power source and the light source and mounted within the blade lock washer to automatically power the light source when the shaft is spinning; wherein the light source projects a light beam from the aperture directed along the plane of the blade to assist the operator in cutting accurately.

This invention relates to a light-emitting rotary saw cut alignment device of the type disclosed in U.S. Pat. No. 6,035,757 (incorporated herein by reference). The inventive assembly accomplishes a light source that is focused and adjusted to the correct angle to the cutting blade, and then fixed in place so that the resulting light beam falls where desired along the cut line at the location where the rotary blade contacts the material being cut.

A key to the successful operation of a light-emitting rotary saw cut alignment device is to have the light beam focused at the proper location relative to the saw and at the proper distance from the device, such that it forms a sharp beam or line at the correct location on the material being cut. Also, the beam needs to intersect the material being cut at the correct point at which the blade will contacting the material being cut. It has been found that these objectives can be accomplished with the construction shown in the drawings, which provide for sufficient structural strength and integrity to allow the device to withstand the rigors (the compressive force and the centrifugal force) of use.

In this invention, the light is emitted from a device that is held on the blade arbor, against the blade. In order to be useful with chop saws and miter saws and all types of rotary saws, it is desirable to have the light beam leave the device housing very close to the surface of the blade, preferably between 0.001 and 0.160 inches from the blade surface. This distance is dictated in part by the thickness of the wall of the device housing that rests against the blade, and in part by the construction and layout of the diode and lens assembly, as more fully described below. Preferably, this construction is such that the beam leaves the housing at a shallow angle that is sufficient to cause the beam to intersect the plane of the cutting blade about six inches to eight feet from the housing. The device can be configured to be turned on or off manually as well as automatically.

### BRIEF DESCRIPTION OF THE DRAWINGS

Other objects, features and advantages will occur to those skilled in the art from the following description of the preferred embodiments, and the accompanying drawings, in which:

FIG. 1 is an exploded view of one embodiment of the cut alignment device of this invention;

FIG. 2 is an exploded view of the device of FIG. 1 and the preferred mounting hardware to mount the device to a saw arbor;

FIG. 3 is a top view of the housing, battery, and electronics for another embodiment of the cut alignment device of this invention; and

FIG. 4 is a top view of the housing, battery, and electronics for yet another embodiment of the cut alignment device of this invention.

### DETAILED DESCRIPTION OF THE PREFERRED EMBODIMENTS

This application is a continuation in part of application Ser. No. 10/207,502 filed on Jul. 29, 2002, the disclosure of which is incorporated herein by reference.

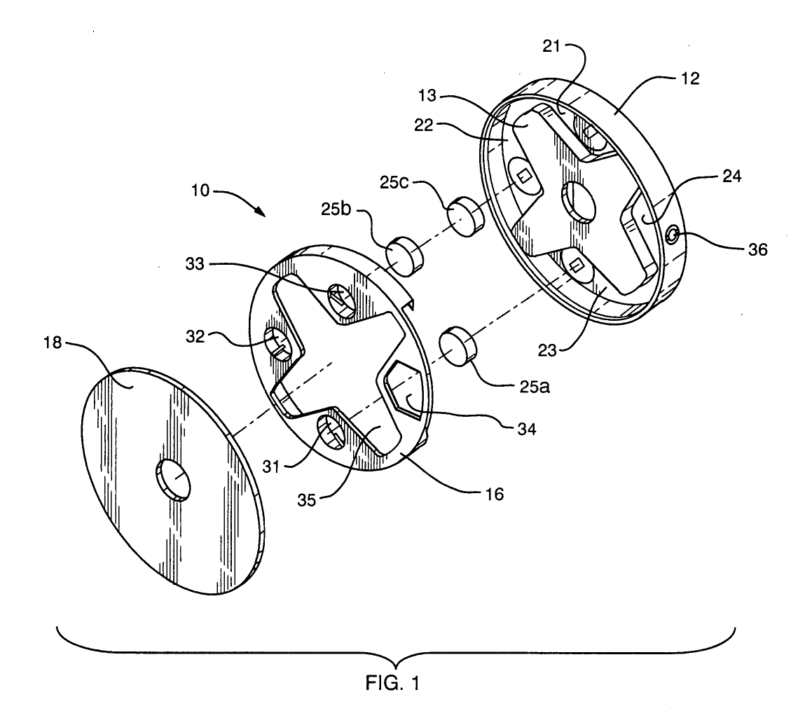

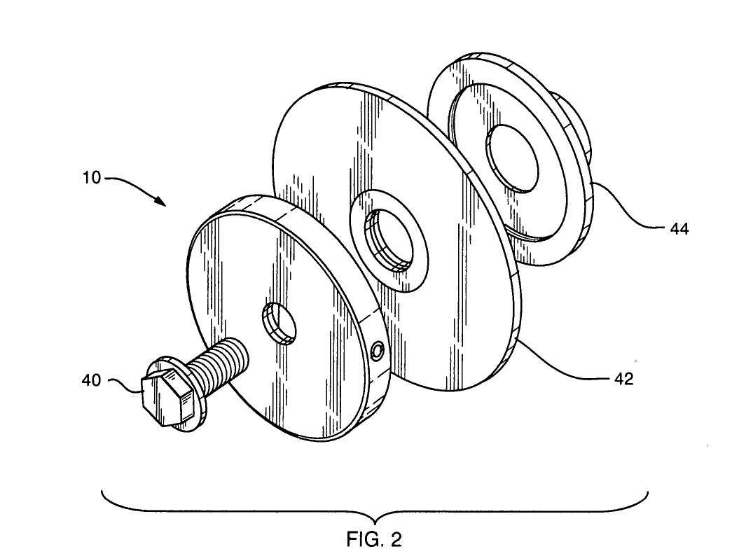

One embodiment of the inventive device is shown in FIGS. 1-2. Device 10 includes stainless steel housing 12 that provides the structural integrity for the device. The raised central four-armed cross-shaped portion 13 of housing 12 is sufficiently thick and strong to protect the electronic components that are located in the pockets 21-24 created thereby (not shown fully in the drawings) so that the components are not crushed when the device is placed on an arbor and the nut is tightened down; it also maintains the integrity of the housing so that it doesn't bend and change the alignment of the laser beam. Also, this construction helps to maintain the device to be sufficiently mass-balanced around the center of the device, so that it is relatively rotationally balanced. Other internal constructions are contemplated herein. For example, internal portion 13 can create 2, 3, 4, or more internal compartments; it can have two or more “arms” radiating from the center; two such arms can be aligned, or not; and the arms can have a desired length, width and thickness. The arms need not be uniform along their lengths, either in width or height. Preferably, their length is from one-eighth inch to the circumferential edge of the housing, and their width is from one-eighth to one-half inches.

Battery holder 16 is a plastic molded part that has three cavities 31-33 to hold and position three button cells 25a-c in a manner such that their tops and bottoms are exposed, so that electrical contact can be made. Holder 16 has a central cross-shaped opening 35 that allows it to fit over the central portion 13 of the housing. Holder 16 also has opening 34 that fits over the electronics and laser (not shown in the drawings). Washer 18 is the cover for assembly 10. A circuit board (not shown) provides the electrical connections between the batteries and from the centrifugally-operated switch (not shown in the drawings) to the laser diode, also not shown. The result is a device that emits light through housing opening 36 only when the arbor to which it is attached is rotating. Details of the electronics are disclosed in U.S. Pat. No. 6,035,757, incorporated herein by reference.

FIG. 2 shows the preferred manner in which device 10 is mounted to the arbor of a rotary saw. Bolt or nut 40 passes through device 10, saw blade 42, and into rear flange 44. Device 10 replaces the washer of a typical rotary saw blade mounting assembly. The device preferably has a thickness between 0.125″ and 0.360″, so that the device does not interfere with the safety guard shield and/or the safety guard shield operating mechanism of the saw.

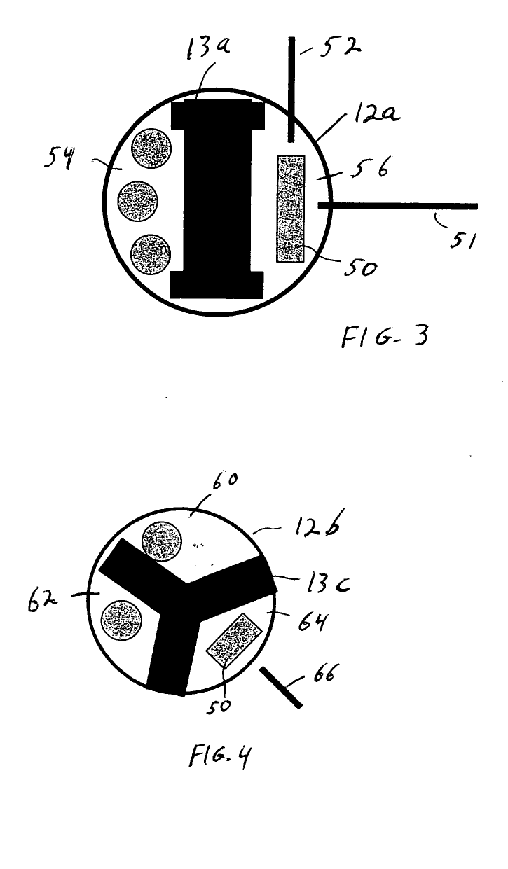

FIG. 3 shows another embodiment of housing 12a with central strengthening/dividing portion 13a having two aligned radial arms. Note that the arms in each embodiment can reach the circumference of the housing, or not. Portion 13a creates compartments or cavities 54 and 56, that house the batteries and the electronics module 50, respectively, as shown. Alternative laser paths 51 and 52 depict the possible directions from which the laser beam is emitted from the housing.

FIG. 4 shows another embodiment of housing 12c with central strengthening/dividing portion 13c having three radial arms, none of which are aligned. Portion 13c creates compartments 60, 62 and 64, that house the batteries and the electronics module 50, respectively, as shown. Laser path 66 is shown.

The device can have a desired diameter. For saws with blades of up to twelve inches in diameter, the device preferably has a diameter of no more than about 2.5″, so that the effective cutting depth of the blade is not impacted. For larger commercial saws having blade diameters of up to 24″, the device may have a diameter of up to 5″. The diameter can be selected to place the laser beam output opening from the housing at a desired distance from the workpiece, while not substantially limiting the cut depth of a particular saw blade.

Although specific features of the invention are shown in some drawings and not others, this is for convenience only as some feature may be combined with any or all of the other features in accordance with the invention.

Other embodiments will occur to those skilled in the art and are within the following claims:

1. A cut alignment device for a rotary saw having a motor which spins a cutting unit, the cutting unit including a rotary shaft driven by the motor, a circular blade having a central aperture through which the shaft fits, and a blade mounting device for holding the blade on the shaft, the cut alignment device comprising:
A structural housing defining at least two internal compartments separated by one or more radial arms;
a battery power source located within the housing; and
a light source, operatively connected to the power source, and located within the housing;
wherein the light source projects a light beam from the housing directed toward the plane of the blade, to assist the operator in cutting accurately.

2. The cut alignment device of claim 1 further including a switch located within the housing and connected between the power source and the light source, for selectively applying power to the light source.

3. The cut alignment device of claim 2 in which the switch is centrifugally engaged, to automatically power the light source when the shaft is spinning.

4. The cut alignment device of claim 1 in which the structural housing accomplishes the blade mounting device, and the blade mounting device defines an aperture from which the light beam emanates.

5. The cut alignment device of claim 4 further including a focusing lens located within the housing and aligned with the aperture for focusing the light from the light source.

6. The cut alignment device of claim 5, wherein the distance between the light source and the lens is adjustable.

7. The cut alignment device of claim 4 in which the structural housing defines a mounting lock washer held on the shaft against the blade.

8. The cut alignment device of claim 4, wherein the distance of the light source from the housing is adjustable, to adjust the angle at which the light beam emanates from the housing.

9. A cut alignment device for a rotary saw having a motor which spins a cutting unit, the cutting unit including a rotary shaft driven by the motor, a circular blade having a central aperture through which the shaft fits, the cut alignment device comprising:
A structural housing defining at least two internal compartments;
a battery power source mounted within one compartment in the structural housing;
a light source operatively connected to the power source and mounted within one compartment in the structural housing, wherein the structural housing defines an aperture from which the light emanates; and
a centrifugally-engaged switch between the power source and the light source and mounted within one compartment in the structural housing, to automatically power the light source when the shaft is spinning;
wherein the light source projects a light beam from the aperture, to assist the operator in cutting accurately.
